(19) United States
(12) Patent Application Publication
(10) Pub. No.: US 2004/0224285 A1
(43) Pub. Date: Nov. 11, 2004

(54) REINFORCED COMPOSITES FOR USE IN DENTAL RESTORATIONS

(75) Inventors: Steven J. DURAY, Rolling Meadows, IL (US); Byoung I. SUH, Oak Brook, IL (US)

Correspondence Address: HOWREY SIMON ARNOLD & WHITE LLP, 750 BERING DRIVE, HOUSTON, TX, 77057, US

(73) Assignee: BISCO, INC., Schaumburg, IL (US)

(21) Appl. No.: 10/249,825

(22) Filed: May 9, 2003

(51) Int. Cl. A61C 13/08

(52) U.S. Cl. 433/212.1; 433/180; 264/16

(57) ABSTRACT

Dental composite restorations reinforced with one or more fiber structures are disclosed. The fiber structures can have a wide array of shapes and sizes, including rods with circular cross sections, rods with “U” shaped cross sections, rods with “I” shaped cross sections, and fiber mesh structures. The reinforced dental composite restorations are created by incrementally layering and curing composite materials onto the fiber structures. The resulting restorations have significantly improved flexural strength as compared to conventionally prepared composite restoration materials.

### BACKGROUND OF INVENTION

1. Field of the Invention

The invention relates to reinforced dental composite materials and, more specifically, to dental composite restoration materials containing reinforcing fiber structures.

2. Description of Related Art

Composites are widely used in the dental field for filling cavities and in creating restorative dental structures. Composites are attractive for use due to their ease of handling, curability, and biocompatibility.

Dental surfaces are subjected to considerable stresses on a daily basis. Significant pressures are placed on surfaces due to natural biting and chewing of foods. If pressures exceed the strength of a dental composite material, a fracture may occur. If the dental materials are not capable of withstanding these pressures for an extended period of time, the materials will ultimately fail, resulting in the need for replacement of the material by a dentist. This is inconvenient, expensive, and potentially painful for the patient.

Efforts have been made to reinforce dental composite materials by adding various components. Ideally, the reinforcing agent would enhance the strength and durability of the composite, while not impacting the biocompatibility or appearance of the composite used in a dental restoration.

U.S. Pat. No. 4,894,012 (issued Jan. 16, 1990) offers the preparation of dental appliances made from a fiber-reinforced composite material comprising a polymeric matrix and a reinforcing fiber component embedded within the matrix. Glass, carbon, graphite, and Kevlar fibers are suggested for use in strengthening the materials. A wide array of thermoplastic materials were discussed as suitable for forming the reinforced matrix.

U.S. Pat. No. 5,445,770 (issued Aug. 29, 1995) proposes the formation of fiber preforms in the preparation of orthodontic brackets. The use of long fibers improves the stiffness and fracture resistance of the formed brackets.

U.S. Pat. No. 6,334,775 B2 (issued Jan. 1, 2002) suggests the use of continuous fiber preforms to reinforce dental restorations. The fibers can be mixed with resin monomers and hardened into preforms suitable for insertion into tooth cavities. The preparation of indirect dental restorations was also discussed.

Composite bridge restorations have been prepared using metal to strengthen the restoration. While strong, metal does have several serious drawbacks limiting its use. Composite resins do not adhere well to the metal, and the color and appearance of metal is considered undesirable to patients, who prefer to have “natural” white appearances in dental restorations.

Despite efforts made to date on enhancing the strength of dental materials by adding fibers, there still exists a need for materials and structures that exhibit high strength in dental applications such as cavity fillings, restoration, and bridges.

### SUMMARY OF INVENTION

Composite materials reinforced with fiber structures are suitable for use in dental restorations. The fiber reinforced structures can be in various shapes such as rods, “U”-bars, “I”-bars, woven meshes, and individual fibers. The reinforced composite materials demonstrate significant improvements in flexural strength as compared to a non-reinforced or conventionally reinforced composite material.

### BRIEF DESCRIPTION OF DRAWINGS

The following figures form part of the present specification and are included to further demonstrate certain aspects of the present invention. The invention may be better understood by reference to one or more of these figures in combination with the detailed description of specific embodiments presented herein.

FIG. 1 is a reinforced dental composite restoration containing one rod having circular cross sections.

FIG. 2 is a reinforced dental composite restoration containing one rod having “U” shaped cross sections.

FIG. 3 is a reinforced dental composite restoration containing one rod having “I” shaped cross sections.

FIG. 4 is a reinforced dental composite restoration containing one rod having “U” shaped cross sections and one rod having circular cross sections.

FIG. 5 is a reinforced dental composite restoration containing one rod having “U” shaped cross sections and two rods having circular cross sections.

FIG. 6 is a reinforced dental composite restoration containing three rods having circular cross sections.

FIG. 7 is a bridge structure containing a rod having “U” shaped cross sections.

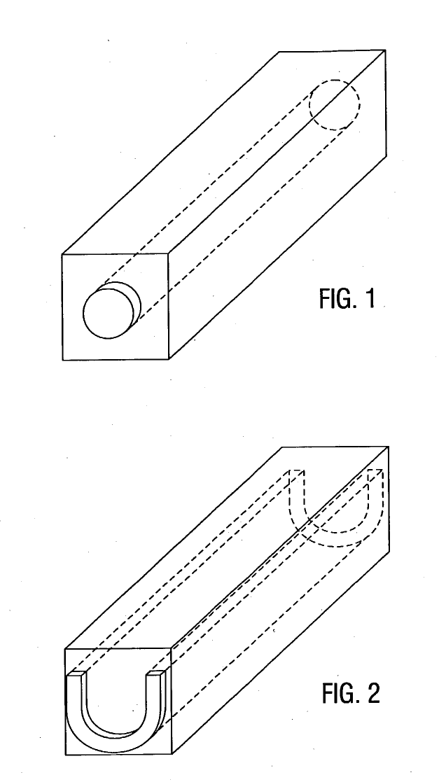

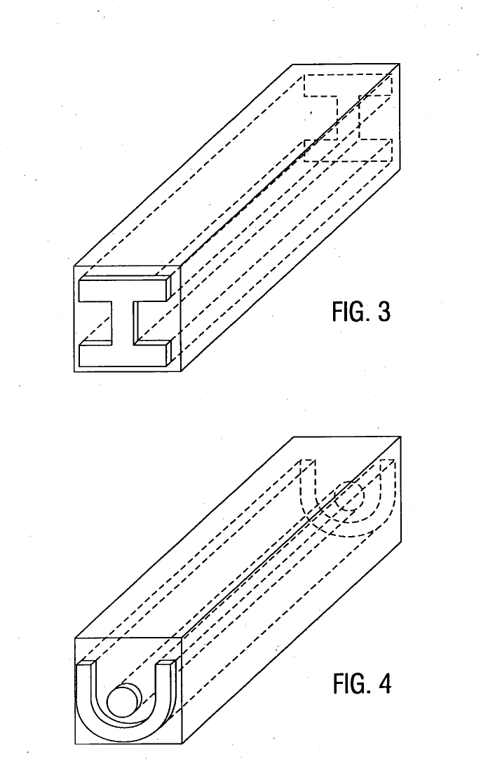

### DETAILED DESCRIPTION

Dental composite materials can be reinforced with fiber structures to form a reinforced dental composite restoration. The reinforced dental composite restorations can be used in an array of dental procedures, including dental restorations between teeth and spanning across several teeth.

Compositions

One embodiment of the invention is directed towards reinforced dental composite restorations. The restorations preferably comprise at least one fiber structure and a composite resin. The restorations can comprise one fiber structure, two fiber structures, three fiber structures, and so on. The multiple fiber structures can be of the same shape or of different shapes.

The reinforced dental composite restorations preferably demonstrate improved flexural strengths as compared to an unreinforced dental composite restoration. For example, unreinforced materials typically have flexural strengths of about 74 MPa to about 107 MPa, while the inventive reinforced dental composite materials have been found to have flexural strengths of about 125 MPa to about 200 MPa. Flexural strengths within this range include about 130 MPa, about 140 MPa, about 150 MPa, about 160 MPa, about 170 MPa, about 175 MPa about 180 MPa, and about 190 MPa. Higher flexural strengths of about 210 MPa, about 220 MPa, about 225 MPa, about 230 MPa, about 240 MPa, about 250 MPa, or ranges between any two of these values may be possible with further optimization of the materials and their method of preparation.

Flexural strengths and elastic modulus of restorations can be measured using the techniques described in the American National Standard/American Dental Association Specification No. 27 1993 for Resin-Based Filling Materials. The apparatus contains two rods (2 mm in diameter), mounted parallel with 20 mm between their centers, and a third rod (2 mm in diameter) centered between, and parallel to, the other two. The three rods in combination can be used to give a three-point loading to the specimen. Specimens are loaded using either a constant cross-head speed (0.75 Â±0.25 mm/min) or load rate (10 Â±16 N/min). The specification also recommends the following dimensions of the specimens: 2 Â±0.1 mm×2 Â±0.1 mm×25 Â±2 mm.

A Q TESTER (MTS Systems Corp.; Eden Prarie, Minn.) universal testing machine can be used for breaking specimens, collecting data, and processing the data to calculate flexural strength and elastic modulus. The Q TESTER is operated using a constant cross-head speed of 0.75 Â±0.25 mm/min, per spec. However, for testing round rods and “U”-bars, larger specimens were prepared in order to have reinforcing materials incorporated in them. The larger specimens tested were 4.5 Â±0.2 mm×4.5 Â±0.2 mm×25 Â±2 mm. For testing specimens containing woven fabric, samples were thinner so they could be compared to a commercially available reinforced sheet material. The dimensions of the woven fabric reinforced specimens were 3.0 Â±0.2 mm (width)×1.3 Â±0.1 mm (depth)×25 Â±2 mm (length). All specimens were stored in distilled water at 37 Â° C. prior to testing. Specimens were tested 24 hours after being prepared.

The fiber structures can generally be made from any form of fiber that is compatible with dental composite materials, and which confers added strength to a dental composite material. For example, the fiber structures can be made from silica fibers, glass fibers, carbon fibers, graphite fibers, quartz, fiberglass, or Kevlar fibers. It is presently preferred that the fiber structures be made from silica fibers.

Fiber structures can be prepared by a method comprising selecting a plurality of fibers, coating the fibers with a resin, and curing the resin. The fibers can optionally be pretensed prior to the coating step. The fiber structures can be cut into a variety of lengths after curing. For example, the lengths can be about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 30 mm, about 40 mm, about 50 mm, about 60 mm, about 70 mm, about 80 mm, about 90 mm, about 100 mm, about 110 mm, about 120 mm, and ranges between any two of these values. Restorations can be partial or full bridges, or can curve around the full plate.

The fiber structures can be formed in a variety of shapes. Shapes include rods with circular cross sections, rods with square cross sections, rods with rectangular cross sections, rods with “I” shaped cross sections, rods with “L” shaped cross sections, and rods with “U” shaped cross sections. Alternatively, the fiber structures can be two dimensional woven meshes or three dimensional structures prepared from woven meshes. The rods can be various sizes in cross section and length. For example, the cross-section diameter (or maximum distance) can be about 1 mm, about 2 mm, about 3 mm, about 4 mm, about 5 mm, or ranges between any two of these values. A specific example is a “U” shaped rod having a height (the distance from the bottom of the curved portion to the opposite end of the two straight portions) of about 4-5 mm, and a width (the distance from one straight portion to the opposite straight portion) of about 3, about 4, or about 5 mm. The woven meshes can be flat (i.e. two dimensional), or can be bent or curved into a variety of three dimensional structures (e.g. half cylinders, bowls, cylinders, spheres, cubes, “L” shapes, “U” shapes, and so on).

Multiple different fiber structures can be combined in the reinforced dental composite material. For example, a rod with a circular cross section can be placed within the concave portion of a rod with a “U” shaped cross section. Alternatively, multiple similar fiber structures can be combined. For example, two or three rods with circular cross sections could be used together in a single restoration. The orientation of the fiber structures can also be varied within the restoration. For example, a “U” shaped rod could be oriented within a restoration such that the concave opening of the “U” is facing towards, facing away, or at right angles to the jaw of a dental patient.

The composite resin can be a self-polymerizing, a heat-polymerizing resin, or a photo-polymerizing resin. Examples of suitable resins include TESCERA Dentin, TESCERA Body, TESCERA Incisal, TESCERA Flo, TESCERA Sculpting Resin, and TESCERA Color Modifiers (all available from Bisco, Inc.; Schaumburg, Ill.). Resins can be polymerized under a combination of conditions, such as light, heat, and pressure. Polymerizations can be performed according to the manufacturer's instructions. Resins can be polymerized at temperatures higher than room temperature (70 Â° F., 21 Â° C.). For example, the TESCERA product (BISCO, Inc.; Schaumburg, Ill.) can be polymerized at up to 135 Â° C., while belleGlass (KerrLab; Orange, Calif.) can be polymerized at up to 140 Â° C Resins can be polymerized at pressures greater than one atmosphere (760 mm Hg). For example, TESCERA can be polymerized at up to 60 psig (4.2 kg/cm²). Resins can also be polymerized at elevated temperatures and pressures. When using light as a polymerization method, various wavelengths, intensities, and times can be used. For example, the VIP light system (BISCO, Inc; Schaumburg, Ill.) can be used.

The restorations can further comprise other materials such as dental posts or fluoride release agents, antimicrobial agents, colorants, dyes, and fluorescing aids.

Methods of Preparation

The fiber structures can be coated with composite resin to form the reinforced dental composite material. The coating can be performed in a mold or without a mold. The fiber structures can be repeatedly coated with thin layers of resin (about 1 mm or about 2 mm thickness) that are allowed to harden before application of the next layer. After multiple iterations, the reinforced dental composite material is prepared in its final form. It is believed that iterative layering of the composite material under pressure onto the fiber structure minimizes the formation of air bubbles and resulting porosity, and results in a restoration having improved flexural strength. Curing with elevated heat (above 70 Â° F. (21 Â° C.)) and/or pressure (above 1 atmosphere ambient pressure) also results in increased flexural strength restorations.

The overall dimensions of the completed reinforced composite dental restoration can be any of the dimensions discussed earlier regarding the fiber structures, including partial or full bridges. The restoration can be partially or wholly shaped to resemble the outer surface of a tooth. The shaping can be performed using a drill, a laser, grinding or other abrasion techniques, or any other commonly used method used to shape dental restorations.

Methods of Use

The reinforced dental composite restorations can be used in single tooth applications or in multiple tooth applications. A single tooth restoration can contain one or more fiber structures no wider than the longest dimension of the tooth (e.g. the width or diagonal distance across the tooth). A restoration can be performed with two or more adjacent teeth. In this case, the fiber structure(s) can be no wider than the combined width of the teeth. A bridge restoration can be performed, where a groove or other recession is formed in the two teeth flanking the bridge site. The fiber structure(s) can be up to the combined width of the teeth.

As described above, the restoration can be used with the fiber structures in various orientations relative to the tooth or jaw of the dental patient.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Physical Assays of Dental Restorations

The flexural strength and elastic modulus of dental restorations can be determined according to the American National Standard/American Dental Association Specification No. 27 1993 for Resin-Based Filling Materials, as described above in the Detailed Description of the Invention. Flexural strengths are commonly measured in MPa. Elastic modulus is commonly measured in GPa.

### Example 2

### Preparation of Reinforced Dental Composite Restorations

Carbon fibers are pressed, sintered, and/or glued together to form a fiber structure. In this Example, the fibers are pretensed prior to formation of the structure.

The fiber structure is coated with a dental bonding agent (ONE-STEP, commercially available from Bisco, Inc., Schaumburg, Ill.) to enhance adhesion of the composite resin to the fiber structure. The bonding agent is allowed to air dry, and is light cured for 10 minutes. The fiber structure is placed within a mold, and coated with a thin layer of TESCERA Body shade B1 composite resin (Bisco, Inc.; Schaumburg, Ill.). Incremental light curing of composite resin is performed in a TESCERA ATL unit (commercially available from Bisco, Inc.; Schaumburg, Ill.) under elevated heat and pressure to minimize or eliminate bubbles and resulting porosity (cured at 130 Â° C. and 60 psig (4.2 kg/cm²)). One light/pressure cycle is used per incremental layering. Incremental layering of composite resin is performed at no more than 2 mm thickness per iteration. The final dental restoration material has acceptable visual opacity and enhanced physical strength.

The dental restoration material can be cut, shaped, or carved into any final anatomy required for a dental restoration procedure.

### Example 3

### Evaluation of the Flexural Strengths and Elastic Modulus of Various Reinforced and Non-Reinforced Dental Restorations

Samples containing “U” bars and round rods were sliced into 30 mm lengths using an Isomet Saw with a diamond wafering blade. Materials were pretreated with ONE-STEP. The materials were coated, air dried, and light-cured for one minute in a Jeneric Pentron Light Box (Pentron Corp.; Wallingford, Conn.). This procedure was repeated three times for each sample.

Samples containing various combinations of “U” bars and round rods were prepared. A control sample of unreinforced composite was also prepared. A custom acrylic mould was used to prepare square bars for 3-point bend testing (4.5 mm square cross section). All specimens were built up in layers using the mould. Each layer was filled to approximately 1 mm in depth and processed in the TESCERA ATL unit using the light/pressure cycle. This was repeated until the last layer. After placing the final layer, the cover was bolted onto the top of the mould. This assembly was processed for one light/pressure cycle. The square-bar was removed from the mould and processed for one heat/light/pressure cycle.

The samples were evaluated for their flexural strength and elastic modulus. The following table shows the beneficial effects of reinforcement of the composites.

| | Flexural strength n_{T} total | |
|---|---|---|
| | # specimens n_{B} # | |
| Structure | specimens that broke | Elastic Modulus |
| Unreinforced | 100 MPa (n_{T} = n_{B} = 7, | 3.7 GPa (n = 7, |
| Composite | s.d. = 14 MPa) | s.d. = 0.1 GPa) |
| Reinforced with 3 | (>179 MPa) (n_{T} = 6, n_{B} = | (3.7 GPa) |
| rods | 3, s.d. = 22 MPa)* | (n^{T} = 6, s.d. = 22 |
| | | MPa)* |
| U-bar unsupported | 110 MPa (n_{T} = n_{B} = 6, | 3.8 GPa (n = 6, |
| (1 rod) | s.d. = 12 MPa) | s.d. = 0.4 GPa) |
| U-bar unsupported | (>170 MPa) (n_{T} = 6, n_{B} = | (4.8 GPa) |
| by tabs at ends (1 | 5, s.d. = 13 MPa)* | (n_{T} = 6, n_{B} = 5, |
| rod) | | s.d. = 13 MPa)* |
| U-bar supported by | (>228 MPa) (n_{T} = 6, n_{B} = | (6.0 GPa) (n = 6, |
| tabs at ends (2 rods) | 2, s.d. = 5 MPa)* | s.d. = 0.2 GPa) |

*Load-to-failure exceeded the limit of the load cell with some samples.

### Example 4

### Comparison of the Flexural Strengths of Various Reinforced and Non-Reinforced Dental Restorations

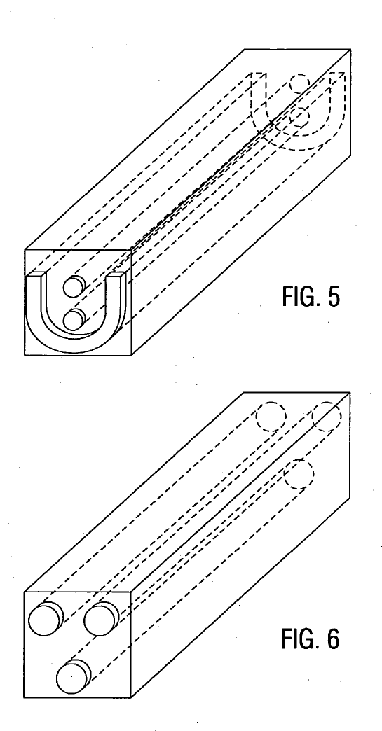

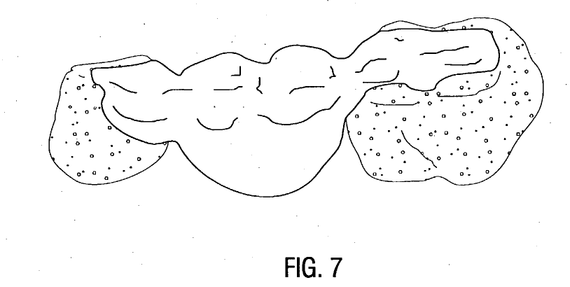

Samples containing no fiber structures (“control”), three rods having circular cross sections, one rod having a “U” shaped cross section and a rod having a circular cross section placed within the cavity of the “U”, and one rod having a “U” shaped cross section and two rods having circular cross sections placed within the cavity of the “U” were prepared and evaluated for flexural strength as described in Example 1.

| Sample | Flexural strength |
|---|---|
| No fibers (control) | 100 MPa |
| One U and one circular rod (FIG. 4) | 170 MPa |
| One U and two circular rods (FIG. 5) | >200 MPa |
| Three circular rods (FIG. 6) | 179 MPa |

### Example 5

### Preparation of Composite Materials Reinforced with Woven Fibers

Fiberglass woven fiber (Fiberglass Reinforcement part# 241-f, 2 oz/sq. yard, Fibre Glast Developments Corporation, Brookville, Ohio) was used in this Example. TESCERA Sculpting Resin (Bisco, Inc.; Schaumburg, Ill.) was used for pretreating the fabric as it wicked into the fiberglass fabric quickly. Twenty layers of stacked fabric (each layer rotated 45 degrees relative to each preceding layer) were placed in an acrylic mold, then saturated with sculpting resin. The saturated fabric was pressed into a wafer (about 1.3 mm thick). The wafer was processed twice in the TESCERA ATL unit with a light/pressure cycle (once per side), after which it was removed from the mould and processed for one heat/light/pressure cycle. The wafer was sliced into 3 mm wide strips for 3-point bend testing. It was found to have a flexural strength of 439 MPa (s.d.=27 MPa, n=10), and an elastic modulus of 17.1 GPa (0.5 GPa, n=10).

### Example 6

### Preparation of Composite Materials Reinforced with Woven Fiberglass Tubing

Fibers can be woven into a three dimensional tube structure. Such structures are commercially available, primarily marketed as high-temperature fiberglass electrical sleeving for wires (e.g. available from SPC Technology; Chicago, Ill., TPC Wire & Cable; Independence, Ohio, and others). The tube structure can fit onto a cylindrical structure such as the top portion of a dental implant or tooth pontic. The tube can then be saturated with TESCERA Sculpting Resin (as in the previous example), and processed with either a light/pressure or light/heat pressure cycle. The resulting structure can be a thin, reinforced polymer tube, custom fitted to the dental implant or tooth pontic. Composite could then be built up on this structure, and cured incrementally as described in the previous examples.

All of the compositions and/or methods and/or apparatus disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and/or apparatus and in the steps or in the sequence of steps of the methods described herein without departing from the concept and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the scope and concept of the invention.

1. A method of preparing a dental restoration material, the method comprising:
providing at least one fiber structure;
iteratively coating and polymerizing more than one layer of composite resin onto the fiber structure to prepare a preform; and
carving the preform to prepare a dental restoration material.

2. The method of claim 1, wherein the polymerizing step is performed at a temperature greater than about 70 Â° F. (21 Â° C).

3. The method of claim 1, wherein the polymerizing step is performed at a pressure greater than about one atmosphere (760 mm Hg).

4. The method of claim 1, wherein the polymerizing step is performed at a temperature greater than about 70 Â° F. (21 Â° C.) and at a pressure greater than about one atmosphere (760 mm Hg).

5. The method of claim 1, wherein the fiber structure is prepared from pretensed fibers.

6. The method of claim 1, wherein the fiber structure is prepared from silica fibers.

7. The method of claim 1, wherein the fiber structure is prepared from carbon fibers, graphite fibers, quartz fibers, fiberglass fibers, or Kevlar fibers.

8. The method of claim 1, wherein the fiber structure is a rod having a “U” shaped cross section.

9. The method of claim 1, wherein the fiber structure is a rod having a “I” shaped cross section.

10. The method of claim 1, wherein the fiber structure is a rod having a circular cross section.

11. The method of claim 1, wherein the fiber structure is fiber mesh structure.

12. The method of claim 1, wherein the fiber structure is fiber mesh cylinder structure.

13. The method of claim 1, wherein two fiber structures are provided.

14. The method of claim 13, wherein the two fiber structures are one rod having a “U” shaped cross section and one rod having a circular cross section.

15. The method of claim 1 wherein three fiber structures are provided.

16. The method of claim 15, wherein the three fiber structures are one rod having a “U” shaped cross section and two rods having a circular cross section.

17. The method of claim 1, wherein the composite resin is TESCERA Dentin, TESCERA Body, TESCERA Incisal, TESCERA Flo, TESCERA Sculpting Resin, or TESCERA Color Modifier.

18. The method of claim 1, wherein each layer of composite resin is no more than about 2 mm in thickness.

19. The method of claim 1, wherein the preform is carved to at least in part resemble the surface of a tooth.

20. The method of claim 1, wherein the preform has a flexural strength of at least about 125 MPa.

21. The method of claim 1, wherein the preform has a flexural strength of about 125 MPa to about 200 MPa.

22. The method of claim 1, further comprising placing the fiber structure in a mold prior to the coating step.

23. The method of claim 1 wherein the dental restoration material is suitable for use in a bridge restoration procedure.

24. A reinforced dental composite restoration comprising at least one fiber structure and a composite resin, wherein the restoration has a flexural strength of at least about 125 MPa.

25. The restoration of claim 24, wherein the fiber structure is prepared from pretensed fibers.

26. The restoration of claim 24, wherein the fiber structure is prepared from silica fibers.

27. The restoration of claim 24, wherein the fiber structure is prepared from carbon fibers, graphite fibers, quartz fibers, fiberglass fibers, or Kevlar fibers.

28. The restoration of claim 24, wherein the fiber structure is a rod having a “U” shaped cross section.

29. The restoration of claim 24, wherein the fiber structure is a rod having a “I” shaped cross section.

30. The restoration of claim 24, wherein the fiber structure is a rod having a circular cross section.

31. The restoration of claim 24, wherein the fiber structure is fiber mesh structure.

32. The restoration of claim 24, wherein the fiber structure is fiber mesh cylinder structure.

33. The restoration of claim 24, wherein the restoration comprises two fiber structures.

34. The restoration of claim 33, wherein the two fiber structures are one rod having a “U” shaped cross section and onerod having a circular cross section.

35. The restoration of claim 24, wherein the restoration comprises three fiber structures.

36. The restoration of claim 35, wherein the three fiber structures are one rod having a “U” shaped cross section and two rods having a circular cross section.

37. The restoration of claim 24, wherein the composite resin is TESCERA Dentin, TESCERA Body, TESCERA Incisal, TESCERA Flo, TESCERA Sculpting Resin, or TESCERA Color Modifier.

38. The restoration of claim 24, shaped at least in part to resemble the surface of a tooth.

39. The restoration of claim 24, wherein the restoration is suitable for use in a bridge restoration procedure.
